(19) United States
(12) Patent Application Publication
(10) Pub. No.: US 2012/0006496 A1
(43) Pub. Date: Jan. 12, 2012

(54) EDGE SEALING GLUE HEAD FOR BONDING SUBSTRATE ASSEMBLY IN SOLAR MODULE DEVICE

(75) Inventors: Yi-Wen TAI, Hsinchu City (TW); Cheng-Pei HUANG, Taipei City (TW); Hao-Kun LIEN, Taipei County (TW)

(73) Assignee: Du Pont Apollo Limited, Hong Kong (HK)

(21) Appl. No.: 13/175,949

(22) Filed: Jul. 4, 2011

(30) Foreign Application Priority Data
Jul. 6, 2010 (CN) 201010222522.8

(51) Int. Cl. B29C 65/78

(52) U.S. Cl. 156/423

(57) ABSTRACT

An edge sealing glue head for bonding a substrate assembly in a solar module device is provided, and includes: an elongated body having a groove along a length direction of the elongated body, wherein the groove has a first side edge, a second side edge and a bottom; and a fixing strip which is in an elongated shape and is connected to the first side edge of the groove along a length direction of the elongated body, thereby contacting a substrate assembly which gets into the groove, wherein the fixing strip, the groove and the substrate assembly collaboratively define a space for an adhesive to fill in.

### RELATED APPLICATIONS

This application claims priority to China Application Serial Number 201010222522.8, filed Jul. 06, 2010, which is herein incorporated by reference.

### BACKGROUND

1. Field of Invention

The present invention relates to an edge sealing glue head for bonding a substrate assembly. More particularly, the present invention relates to an edge sealing glue head for bonding a substrate assembly in a solar module device.

2. Description of Related Art

FIG. 1A and FIG. 18 are cross-sectional views each showing a substrate assembly and an edge sealing glue head of a solar module device 100 after being assembled by using a respective conventional technique. A solar cell layer 115 is formed on a glass substrate 114, and an encapsulating material layer 117, such as ethylene-vinyl acetate (EVA), is placed on the solar cell layer 115, and another glass substrate 112 is placed on the encapsulating material layer 117, wherein all of the former components integrally form a substrate assembly 110. For illustration, the components of FIGS. 1A and 1B are not drawn to scale, and the solar cell layer 115 and the encapsulating material layer 117 are drawn thicker than actual layers.

The difference between FIG. 1A and FIG. 1B lies in that the edge sealing glue head for bonding the substrate assembly adopts a C-shaped frame 104 in FIG. 1A but adopts an L-shaped frame 108 in FIG. 1B. The inner side of the frame (the C-shaped frame 104 or the L-shaped frame 108) contacts the substrate assembly 110, and then hot melt glue is used as an adhesive and the hot melt glue after being heated is filled in the spaces 105, 107 between the frame and the substrate assembly.

However, either the C-shaped frame 104 or the L-shaped frame 108 easily results in the situation of nonuniform adhesive coating (which is thicker, to thinner or slanted), and thus the result of assembling the frame and the substrate assembly is affected. Such a situation is more serious in the process of assembling a large substrate assembly, because the larger the substrate assembly is, the greater the deformation or tilt is, thus easily resulting in nonuniform adhesive coating.

In addition, a hot melt glue coating machine with necessary heating equipment is heavy and is hard to be controlled, and meanwhile a glue gun cannot be directly controlled manually due to an over-high temperature. Furthermore, since the hot melt glue needs to be heated and itself has high viscosity and the hot melt glue gun cannot have an injection orifice as fine as a needle tip, the precision of coating cannot be ensured.

Due to the foregoing reasons, the conventional technique of installing the substrate assembly by using the hot melt glue as an adhesive is heavy and clumsy in operation and lacks flexibility, and also lacks coating precision. Particularly, when two overlapped large glass substrates (such as the glass substrates of the solar module device) are bonded as a substrate assembly, the edges of the substrate assembly are easy to be tilted due to its large area, and thus it is difficult to coat the adhesive therein uniformly on the edges of the substrate assembly.

If the adhesive is not uniformly coated on the edges of the substrate assembly, the edges of the substrate assembly cannot be sealed, and thus the moisture will penetrate and influence the power generation efficiency of the solar module device.

Therefore, there is a need to develop an edge sealing glue head and an adhesive for uniformly coating the adhesive on the edges of the substrate assembly when the substrate assembly is being assembled.

### SUMMARY

The summary aims to provide a brief description of the disclosure so that readers can understand the disclosure fundamentally. The summary does not describe the disclosure completely, and does not intend to specify the important/critical elements of the embodiments of the present invention or limit the scope of the present invention.

Therefore, an aspect of the present invention is directed to providing an edge sealing glue head for uniformly coating an adhesive on the edges of the substrate assembly when the substrate assembly is being assembled.

An aspect of the present invention is directed to providing an edge sealing glue head for bonding a substrate assembly in a solar module device, wherein the edge sealing glue head includes an elongated body having a groove along a length direction of the elongated body, and the groove has a first side edge, a second side edge and a bottom; and a fixing strip which is in an elongated shape and is connected to the first side edge of the groove along a length direction of the elongated body, thereby contacting the substrate assembly which is inserted into the groove, wherein the fixing strip, the groove and the substrate assembly collaboratively define a space for filling an adhesive therein.

According to an embodiment of the present invention, a portion of the fixing strip contacting the substrate assembly further includes an elastic pad for avoiding damaging the substrate assembly.

According to another embodiment of the present invention, the elastic to pad is made of a heat resistant material.

According to yet another embodiment of the present invention, the fixing strip and the elongated body are integrally formed as one piece.

According to a further embodiment of the present invention, the fixing strip and the elongated body are formed from the same material.

According to an exemplary embodiment of the present invention, the groove further includes an obstruction block disposed between the substrate assembly and a bottom of the groove for controlling a coating range of the adhesive on the bottom of the groove.

According to another exemplary embodiment of the present invention, the second side edge of the groove has a bevel for allowing the substrate assembly to be easily inserted into the groove, thereby preventing the deformation of the substrate assembly.

According to still another exemplary embodiment of the present invention, the adhesive is a photo-curing resin.

According to a further exemplary embodiment of the present invention, the substrate assembly includes two overlapped glass substrates.

According to yet another exemplary embodiment of the present invention, the substrate assembly includes a glass substrate and a back plate which are overlapped with each other.

With reference to the following detailed description, one of ordinary skill in the art will easily understand the basic spirit, objectives, techniques and implementation aspects of the present invention.

### BRIEF DESCRIPTION OF THE DRAWINGS

The above and other objectives, features, advantages and embodiments of the present invention can be more fully understood with reference to the accompanying drawings as follows:

FIG. 1A is a cross-sectional view showing a substrate assembly and an edge sealing glue head of a solar module device after being assembled by using a conventional technique, wherein the edge sealing glue head for bonding the substrate assembly adopts a C-shaped frame;

FIG. 1B is a cross-sectional view showing a substrate assembly and an edge sealing glue head of a solar module device after being assembled by using another conventional technique, wherein the edge sealing glue head for bonding the substrate assembly adopts an L-shaped frame; and

FIG. 2 is a schematic view of a solar module device according to an embodiment of the present invention.

### DETAILED DESCRIPTION

To make the contents of the present invention more thorough and complete, the following illustrative description is given with regard to the implementation aspects and embodiments of the present invention, which is not intended to limit the scope of the present invention. The features of the embodiments and the steps of the method and their sequences that constitute and implement the embodiments are described. However, other embodiments may be used to achieve the same or equivalent functions and step sequences.

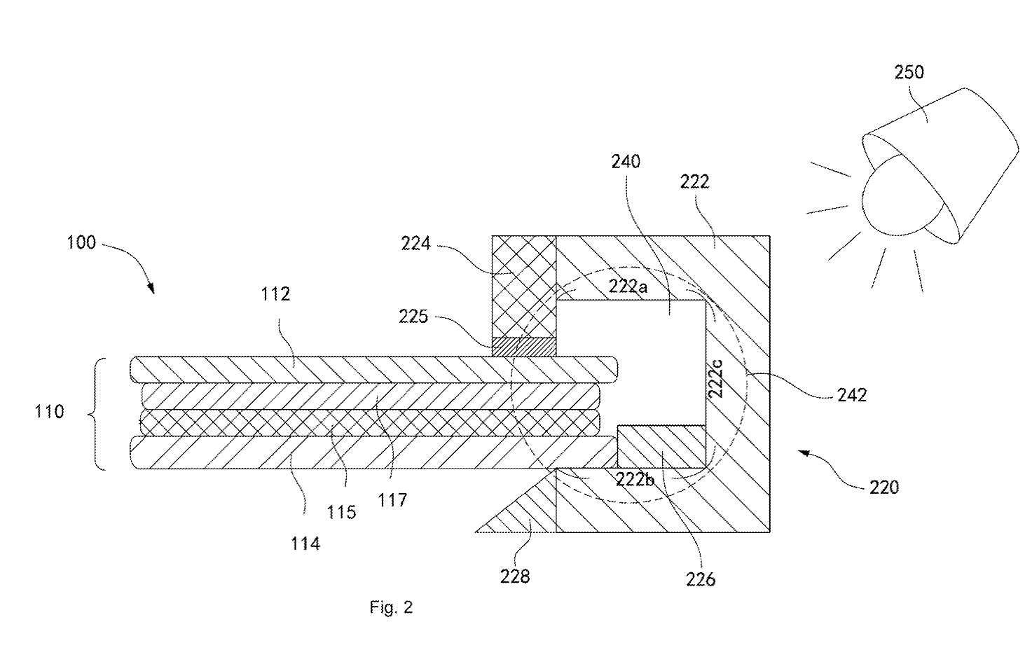

FIG. 2 is a schematic view of a solar module device according to an embodiment of the present invention.

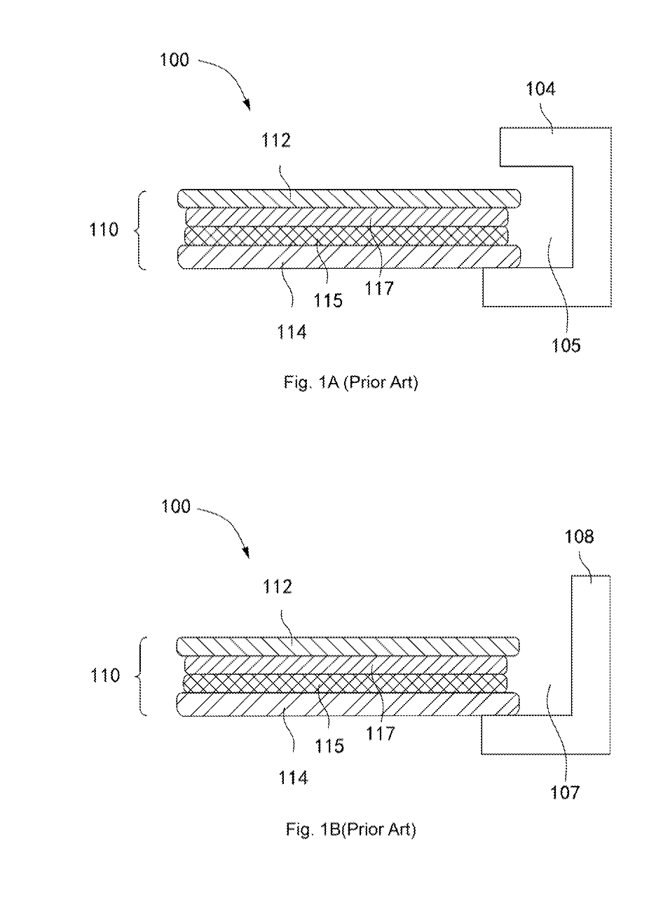

The present invention provides an edge sealing glue head 220 for performing edge sealing coating on the substrate assembly 110 of the solar module device 100 shown in FIG. 1. The edge sealing glue head 220 includes an elongated body having a groove 222 along a length direction of the elongated body, and a fixing strip 224, wherein the groove 222 has a first side edge 222a, a second side edge 222b and a bottom 222c; and the fixing strip 224 is in an elongated shape and is connected to the first side edge 222a of the groove 222 along a length direction of the elongated body, thereby contacting a substrate assembly 110 which inserted into the groove 222.

The fixing strip 224, the groove 222 and the substrate assembly 110 collaboratively define a space 240 in a contact area 242 of the substrate assembly 110 and the edge sealing glue head 220, and an adhesive may be filled in the space 240 for performing an edge sealing coating process on the edges of the substrate assembly 110. Thereafter, the edge sealing glue head 220 is removed, and after the adhesive is cooled down, the adhesive is fixed on the edges of the substrate assembly 110 and then the edge sealing coating process is finished.

Therefore, the present invention has an advantage that the fixing strip 224 can be used to accurately define the space 240 for accommodating the adhesive, thereby precisely controlling the coating range and dosage of the adhesive.

The adhesive can be hot melt glue or a photo-curing resin. In other words, if the adhesive is a photo-curing resin, the adhesive does not need to be heated when being coated, and is merely needed to be filled in the space 240 and then be cured by irradiation of a light source 250 having a specific wavelength.

Therefore, the present invention has another advantage of using light and convenient coating equipment and precisely controlling the edge sealing glue head.

Optionally, the portion of the fixing strip 224 contacting the substrate assembly 110 may further include an elastic pad 225 which has elasticity for avoiding damaging the substrate assembly 110 when the substrate assembly 110 is being assembled into the groove 222.

When the substrate assembly 110 is being assembled into the groove 222, the elastic pad 225 is placed in a rather high temperature environment, and thus the elastic bumper 225 is preferably a heat resistant material.

Furthermore, a fixing strip 224 may be a structure additionally attached to the elongated body, and may be integrally formed with the elongated body to become a portion of the elongated body. The fixing strip 224 may also have the same material as that of the elongated body.

Optionally, the groove 222 may further include an obstruction block 226 disposed between the substrate assembly 110 and the bottom 222c of the groove 222, thereby controlling a coating range of the adhesive on the bottom 222c of the groove 222.

Furthermore, the second side edge 222b of the groove 222 has a bevel 228 for allowing the substrate assembly 110 to be easily inserted into the groove 222 along the bevel 228, thereby preventing the deformation of the substrate assembly 110.

The substrate assembly 110 may include two overlapped glass substrates, or may include a glass substrate and a back plate overlapped with each other.

Although the present invention has been described in considerable detail with reference to certain embodiments thereof, other embodiments are possible. Various alternations and modifications can be made to these certain embodiments by those skilled in the art without departing from the spirit and scope of the present invention. Such alternations and modifications are intended to fall within the scope of the appended claims.

What is claimed is:

1. An edge sealing glue head for bonding a substrate assembly in a solar module device, the edge sealing glue head comprising:
an elongated body having a groove along a length direction of the elongated body, the groove having a first side edge, a second side edge and a bottom; and
a fixing strip which is in an elongated shape and is connected to the first side edge of the groove along a length direction of the elongated body, thereby contacting the substrate assembly which is inserted into the groove,
wherein the fixing strip, the groove and the substrate assembly collaboratively define a space for filling an adhesive therein.

2. The edge sealing glue head of claim 1, wherein a portion of the fixing strip contacting the substrate assembly further comprises an elastic pad used for avoiding damaging the substrate assembly.

3. The edge sealing glue head of claim 2, wherein the elastic pad is made of a heat resistant material.

4. The edge, sealing glue head of claim 1, wherein the fixing strip and the elongated body are integrally formed as one piece.

5. The edge sealing glue head of claim 1, wherein the fixing strip and the elongated body are formed from the same material.

6. The edge sealing glue head of claim 1 or 2, wherein the groove further comprises:
an obstruction block disposed between the substrate assembly and the bottom of the groove, thereby controlling a coating range of the adhesive on the bottom of the groove.

7. The edge sealing glue head of claim 2, wherein the groove further comprises:
an obstruction block disposed between the substrate assembly and the bottom of the groove, thereby controlling a coating range of the adhesive on the bottom of the groove.

8. The edge sealing glue head of claim 1, wherein the second side edge of the groove has a bevel for allowing the substrate assembly to be easily inserted into the groove, thereby preventing the substrate assembly from being deformed.

9. The edge sealing glue head of claim 2, wherein the second side edge of the groove has a bevel for allowing the substrate assembly to be easily inserted into the groove, thereby preventing the substrate assembly from being deformed.
